(19) United States
(12) Patent Application Publication
(10) Pub. No.: US 2025/0209427 A1
(43) Pub. Date: Jun. 26, 2025

(54) An Automotive Attention Blockchain Token System For Tracking Media Consumer's Time And Attention On Websites

(71) Applicant: Daniel Resendiz, Aurora, IL (US)

(72) Inventor: Daniel Resendiz, Aurora, IL (US)

(21) Appl. No.: 18/813,155

(22) Filed: Aug. 23, 2024

Related U.S. Application Data
(60) Provisional application No. 63/534,404, filed on Aug. 24, 2023.

(51) Int. Cl. G06Q 10/20; G06Q 10/087; G06Q 30/0282

(52) U.S. Cl. CPC G06Q 10/20; G06Q 10/087; G06Q 30/0282

(57) ABSTRACT

The present invention relates to an automotive attention blockchain token system for tracking the usage information of a consumer using the website. The present invention further provides for a method to efficiently distribute advertising money between advertisers, publishers and readers of online marketing content and advertisements. A unique aspect of the present invention involves the operation of encompassing features targeting the automotive service industry. These features include comprehensive service and maintenance records, automated notifications, enhanced accident and insurance history, service facility information and ratings, repair facilities and insurance company ratings, technicians' credentials, an interactive blog and payment portal, efficient parts procurement, and a resource hub for all automotive services.

### PRIORITY INFORMATION

Applicant claims priority to and the benefit of provisional application No. 63/534,404 filed on Aug. 24, 2023.

### FIELD OF THE INVENTION

The present invention relates to an automotive attention blockchain token system for tracking the usage information of a consumer using the website. The present invention further provides for a method to efficiently distribute advertising money between advertisers, publishers and readers of online marketing content and advertisements. A unique aspect of the present invention involves the operation of encompassing a host of features targeting the automotive service industry. These include comprehensive service and maintenance records, automated notifications, enhanced accident and insurance history, service facility information and ratings, repair facilities and insurance company ratings, technicians' credentials, an interactive blog and payment portal, efficient parts procurement, and a resource hub for all automotive services.

### BACKGROUND OF THE INVENTION

As the world continues to evolve, technology becomes increasingly intertwined with various sectors, transforming the way we live, work, and even drive. The automotive industry, since the advent of the Ford Model T, has never had the ability to use technology to control and monitor aspects of vehicle ownership such as the repair, service, parts replacement and warranty of a vehicle. There is a need to have elevated efficiency, increased safety, superior consumer experiences, and a comprehensive hub for all automotive services and resources. the blockchain technology of the present invention addresses the need in the automotive and vehicle industry.

In the complex ecosystem of the automotive industry, the consumer experience often revolves around trust, and unfortunately, it can sometimes be found wanting. Consumers are typically leery of the uncertainty surrounding the quality of parts used during repair, questioning the thoroughness of service and maintenance activities, or having reservations about the accuracy of vehicle history reports. This lack of transparency and assurance in the auto repair process has long been a concern for consumers.

There is a need for technology that addresses the monitoring and servicing of the vehicle itself to encompass a diverse range of services, including maintenance, repairs, sales, and insurance, positioning. The platform of the present invention offers a solution to the myriad of challenges facing the contemporary automotive industry.

The problem the current invention aims to solve is highlighted by the issue of consumer assurance in the auto repair process and the potential for delivering high consumer satisfaction, all while casting a light on the broader blockchain landscape within the automotive industry.

In today's highly digitized world, trust is increasingly becoming a cornerstone of the consumer experience. The automotive industry, being a significant pillar of the global economy, is no exception. From purchasing vehicles to routine maintenance and repair work, the entire lifecycle of a vehicle involves multiple touchpoints that can potentially disrupt consumer trust.

The automotive parts market, in particular, has been vulnerable to an influx of counterfeit products and substandard labor practices. A study by the Organization for Economic Cooperation and Development (OECD) in 2019 revealed that imported fake goods make up nearly 3.3% of world trade, with automotive parts being one of the most counterfeited goods. Although it is difficult to isolate counterfeit auto parts' precise contribution, it's worth noting that the automotive parts industry is a substantial part of the global market, valued at over $700 billion. Even a small percentage of counterfeit parts can translate into billions of dollars, contributing to a serious trust deficit.

This trust deficit extends beyond counterfeit parts to auto repair and maintenance. Consumers often express concern about the lack of transparency in parts usage, service charges, and quality of service. According to a 2019 AAA survey, 85% of Americans reported that they mistrust repair shops in general. This mistrust often stems from the fear of being overcharged, suspicion of unnecessary repairs, poor past experiences, or a lack of knowledge about the repairs needed.

Additionally, the ability to verify a vehicle's history, including maintenance, repair, and accident records, is an area where transparency is needed. In a 2018 Consumer Reports survey, around 57% of respondents reported getting a vehicle history report before buying a used cars. However, the same survey also revealed that 30% of those who did buy a used car encountered problems such as unexpected repairs and safety issues not disclosed by the seller.

The quality and reliability of service providers is another critical trust factor. While online review platforms exist, their credibility has often been questioned. A recent BrightLocal survey found that 82% of consumers have read a fake review in the last year.

There is a pressing need for a solution that increases transparency, instills trust, and assures quality at every stage of the automobile life. Blockchain technology, known for its stability, transparency, and decentralization.

Indeed, while other sectors are fast-tracking their transformation to a digital review system, the autobody market appears to be lagging. Current repair shop experiences can often be frustrating and offer an environment ripe for fraudulent practices.

For instance, the process of acquiring and installing automotive parts is ripe with fraudulent practices. Upon diagnosing a problem, a repair shop orders a part, often showing the customer an invoice or order confirmation from a reputable brand. However, there is no way for the customer to verify whether the part installed in their vehicle is the exact part ordered, or a cheap, counterfeit replacement. This lack of transparency can lead to instances where the repair shop returns the original part and substitutes it with a counterfeit part. For the average customer, detecting such malpractices is next to impossible, given the intricacies of vehicle systems.

Moreover, inconsistent pricing adds to the confusion. Customers often face significant disparities in cost estimates for the same repair job across different repair shops. This inconsistency, largely stemming from the absence of standardized pricing, creates a breeding ground for overcharging and dubious pricing practices. Not only does this engender mistrust, but it also leaves customers feeling uncertain and financially exploited.

Even the practice of recording and tracking a vehicle's service history is antiquated. Many auto repair shops still rely on paper records or rudimentary digital spreadsheets. These forms of record-keeping are not only susceptible to human error but also loss, theft, and manipulation. A vehicle's service history is crucial to its value and safety, and any compromise on its accuracy or authenticity can pose serious risks.

Furthermore, the quality of service is often a gamble. With no centralized, reliable platform to verify a technician's credentials or a repair shop's certifications, customers are left to rely on word-of-mouth recommendations or online reviews, which, as previously discussed, can be manipulated.

The automotive repair industry is in dire need of technological intervention. By leveraging blockchain's inherent features of transparency, immutability, and security, the invention can address these prevalent issues. The adoption of such advanced technology in the autobody market can pave the way for enhanced trust, reliability, and consumer satisfaction, ultimately revolutionizing the entire automotive repair experience.

One of the key trends in this market is the rising demand for technological advancement and digitization in automotive repair services. Consumers today seek transparency, speed, and convenience in their interactions with auto repair services, much like they do with any other service industry.

The advent of connected cars and IoT has already started to reshape the automotive repair and maintenance services industry. Advanced diagnostics can now identify potential issues before they become severe, alerting vehicle owners to seek maintenance proactively. By integrating blockchain technology into this mix, the system of the current invention can create a secure, transparent, and efficient system that further enhances consumer trust and satisfaction.

There is a need in the vehicle repair industry for transparency, accuracy and reliability in the function and process of vehicle repairs. The present invention addresses the growth of connected and electric vehicles, and the increasing acceptance of blockchain across industries.

### SUMMARY OF THE INVENTION

The present invention utilizes blockchain technology to effectively monitor, oversee and make transparent the vehicle repair and service and create a database of information associated with the particular vehicle. At the forefront of the present invention is a blockchain-based solution. The present invention utilizes an innovative automotive-based Basic Attention Token implementing the Ethereum blockchain to create a highly reliable and efficient platform for tracking a consumers' time and attention on websites through the web browser.

The present invention utilizes a website application which provides a broad array of features designed to enhance the overall automotive experience for all stakeholders. These features range from comprehensive service records, maintenance records, automated notifications, accident and insurance history tracking, service facility information and ratings, a hub for technicians' credentials, an interactive blog, a secure payment portal, and a parts procurement module.

The functionality of the present invention lies in the unique ability to track auto parts using blockchain technology. This provides a reliable history of parts usage and warranties, offering vehicle owners, repair facilities, and insurance companies a trustworthy and verifiable source of information. Consequently, the invention not only fosters high consumer trust and satisfaction but also provides the opportunity for increased transparency and efficiency within the broader automotive industry. The system operates to provide a user with detail information relating to either routine maintenance or an unexpected repair.

The present invention is an automotive based “Basic Attention Token”, a blockchain-based system that operates within a web application. Built on the Ethereum platform, blockchain's primary goal is to distribute advertising money efficiently between advertisers, publishers, and readers of online marketing content and ads. It extends its functionality to encompass a host of features targeting the automotive service industry. These include comprehensive service and maintenance records, automated notifications, enhanced accident and insurance history, service facility information and ratings, repair facilities and insurance company ratings, technicians' credentials, an interactive blog and payment portal, efficient parts procurement, and a resource hub for all automotive services.

One aspect of the present invention is that customers use an automotive attention token blockchain browser to search for automotive services, qualifications and ratings.

Another advantage to the present invention is that customer receives token, credits, exclusive offers for using software/app.

Yet another advantage of the present invention is the customer receives service reminders and auto scheduling with providers.

Still another advantage of the present invention is the use off a scan-obd plug in connect to software/app to gather and store all the data.

The present invention provides for collision first notice to all parties of interest (delegated by primary account holder) family, insurance, tow company, dealer.

Another feature of the present invention is the creation of a data file associated with each vehicle and any service work performed will be added to the vehicles data file which provides for the full documentation of vehicle repair, service, parts replacement and warranty wherein the data file includes repair shop, shop certification, technician, technicians credentials, parts usage, warranties, insurance claim information;

The present invention provides for the creation of a detailed employment hub where registered technician can browse shop details such as shop certification, technician, technicians credentials, parts usage, warranties, insurance claim information

The present invention also provides for a system for ratings of all these items listed by shop such as parts usage, insurance companies, client information, technician rating and certification, and warranty information.

The system of the present invention provides that all parts usage will be documented by type of part, where the part was purchased, purchase price, quantity and warranty information. The necessary parts and services will be purchased through the software in the app.

The invention provides for the repair shop to post on the application a scan showing the work performed the certifications such as for example, an alignment check, “brand reassurance” to the customer “OEM repair seal of approval.”

The algorithm of the present invention provides for a pre-repair and post-repair scan that is conducted on the vehicle and the information is saved into a database.

The system provides a vehicle maintenance scorecard including recognition of certain maintenance items such as oil changes, brakes, washes etc.

The system provides documentation which is used to score a value score of the vehicle whereupon the value score may vary where certain repairs contribute to vehicles value while other features establish a diminished value for the vehicle. The value score is used to determine the work needed to be performed on the vehicle.

There may be an inspection of repair by certified OEM shop and dealer.

The invention will provide the vehicle with value score for the vehicle based on the parameters for the work performed on the vehicle which the current owner of original repair and new owner of vehicle may access when they register on the application. The system provides reminders of required services based on the data and value score which helps a vehicle owner to achieve the maximum value score associated with the vehicle.

The invention recognizes that the value score for the vehicle is determined by the input of true and verified data associated with the vehicle repair and service. The value score allows the owner, repair shop and dealer to recognize the highest resale value of the vehicle based on the value score.

The application operators to measures and target an owner of a vehicle based on the data received by vehicle owner, repair shop dealership to determine the value score. The application provides initiatives based on the live vehicle value score and will provide recommendations to improve the value of the vehicle.

### DRAWINGS

Drawings of the preferred embodiment are described below:

FIG. 1 is a system overview of the current invention showing the interaction between users;

FIGS. 2(A), 2(B) and 2(C) are a system shown for used on various platforms;

FIG. 3(A) is a screen shot showing the flow for active jobs;

FIG. 3(B) is a screen shot showing the Estimate for an active job;

FIG. 3(C) is a screen shot showing a call out from the parts store;

FIG. 3(D) is a screen shot showing the location of a part;

FIG. 3(E) is a screen shot showing a vehicle vin number used for scanning the parts number;

FIG. 3(F) is a screen shot showing a discussion forum;

FIG. 3(G) is a screen shot showing the certifications;

FIG. 3(H) is a screen shot showing a camera location for a camera shot;

FIG. 3(I) is a screen shot showing the system of the current invention installed on an iPad;

FIG. 3(J) is a screen shot showing a technician and the credentials for that technician;

FIG. 3(K) is a screen shot showing the network of technicians;

FIG. 4(A) is a step-by-step flow chart of the operative system of the current invention demonstrating the blockchain software;

FIG. 4(B) is a step-by-step flow chart of the operative system of the current invention demonstrating a technician using the blockchain software;

FIG. 4(C) is a step-by-step flow chart of the operative system of the current invention demonstrating a technician screen after the scan of the vin number;

FIG. 4(D) is a step-by-step flow chart of the operative system of the current invention demonstrating a customer rating system;

FIG. 4(E) is a step-by-step flow chart of the operative system of the current invention demonstrating a technician screen after the scan of the vin number;

FIG. 4(F) is a step-by-step flow chart of the operative system of the current invention demonstrating a secure payment portal;

FIG. 4(G) is a step-by-step flow chart of the operative system of the current invention demonstrating listing of services;

FIG. 4(H) is a step-by-step flow chart of the operative system of the current invention demonstrating a technician screen after the scan of the vin number;

FIG. 5 is a description of the parts in an integrated social networking platform;

FIG. 6 is a depiction of the glasses utilized in one embodiment of the invention; and

FIG. 7 is a flowchart of the present invention.

### DETAILED DESCRIPTION OF THE PREFERRED EMBODIMENTS OF THE INVENTION

The present invention is described in detail with reference to the drawings attached to this provisional application.

At the heart of solution of the present invention is the ability to provide transparent and verifiable service, maintenance, and repair records. By leveraging blockchain technology, the application of the present invention ensures that each recorded transaction or activity is time-stamped, transparent, and tamper-proof. This reduces the possibility of falsified records and provides a trustworthy account of a vehicle's service history. Consumers can verify if the replacement parts are original, track the vehicle's maintenance, and verify warranty claims.

Moreover, the application of the present invention includes an automated notification file and notice that act as reminders for scheduled services, thereby reducing the chance of missed maintenance and ensuring the vehicle's optimal performance. With service facility ratings and technician credentials made transparent, consumers can make informed choices and select service providers that have a proven track record of delivering quality service.

The present invention utilizes Blockchain Technology and Auto Parts Tracking. The revolutionary aspect of application of the present invention lies in its innovative use of blockchain technology for tracking automotive parts. Blockchain's core principle is a distributed ledger that provides an immutable, transparent record of all transactions occurring across a network.

When a new part enters the supply chain, a unique digital token is created on the blockchain. This token represents the physical part and contains important information such as the manufacturer's details, date of production, and unique product identifier. As the part moves through the supply chain, each transaction (such as sales, installations, or repairs) is recorded on the blockchain, creating a verifiable history of the part's journey.

This level of transparency enables vehicle owners, service providers, and insurers to verify the authenticity and history of the parts used in repairs and maintenance. This process dramatically reduces the chances of counterfeit parts entering the system, as each part's origin and journey are traceable and verifiable.

By combining the power of blockchain with an intuitive, user-friendly interface, the present invention provides a solution that enhances consumer trust, increases transparency, and reduces fraudulent practices in the automotive service and repair industry. The present invention's use of blockchain technology represents a significant step forward in creating a more transparent and trust-worthy auto repair industry.

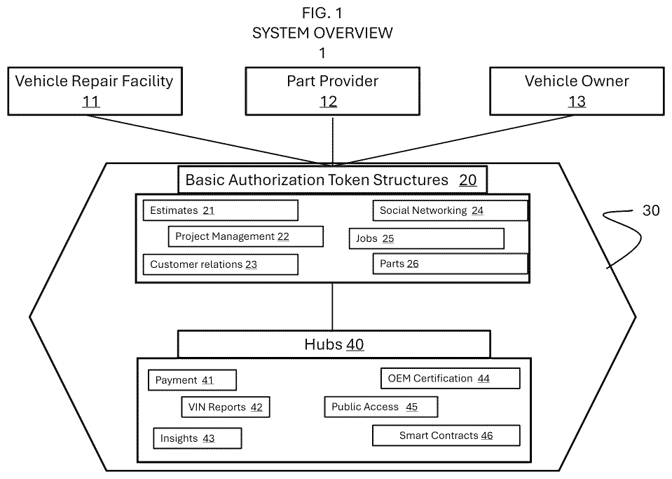

An overview of the system is shown in FIG. 1, in general system 1 has a series of users 10. The users may include vehicle repair facilities 11, parts providers 12, vehicle owners 13, and insurance companies 14. The users are connected to a basic attention token blockchain structure 20 that operates to coordinate various features of the structure with the users 10. The token blockchain structure 20 includes such features as estimates 21, project management software 22, consumer relations 23, networking function via website platform 24, jobs 25 and part information 26. The system 1 also employs a series of hubs 40 which include payment 41, VIN reports 42, insight (help) 43, OEM certification 44, public access 45 and smart contacts 46. The system may be based on a web-based platform 30 or another suitable platform.

The estimate 21 is an online estimating tool enabling fast, accurate and transparent job bids. Industry first features such as side by side supplement modification analysis, remote damage assessments and end to end digital (no phone call) estimate scheduling/assessment/delivery. The project software 22 is designed to coordinate repair procedures, ensure safe outcomes and feed pertinent data into various subsystems. The consumer relations management 23 coordinates with online customer accessibility for seamless B2C interactions. The jobs feature 25 provides resource specifically tailored to automotive talent. The parts feature 26 provides a marketplace allowing part vendors to compete side by side.

The hubs provide the core features. The payments hub 41 provides B2B and B2C payment hub designed to streamline payment collection featuring direct integration with select FinTech brands such as Stripe, PayPal, Apple Pay, Google Pay, Venmo and Crypto intermediaries. The VIN Reports 42 provides comprehensive report featuring granular vehicle details and histories to provide an accurate assessment of value and safety standards within the resale market. Vastly superior to CARFAX, KBB, Auto Check and similar reports. The insights (help) feature 43 provides usage data aggregate imported daily from features. Organized categorically for third party consumption. The OEM Hub 44 provides online certification courses, continuing education credits and repair guidelines. Public information resource 45 is aimed at providing vehicle owners with trade insights to assist with assisting in collision repair decisions and resale purchasing. The smart contracts 46 feature provides provisions, auto part warranties and vehicle rental agreements made official via smart contracts.

Each core feature has a built-in revenue model enabling all subsegments of Automotive to stand independently. A freestanding modular architecture will allow 1) ROI determination by feature set and 2) subsegments of the platform to be sold if an acceptable opportunity arises.⋅ Estimates 21—Monthly fee imposed onto repair facilities. Includes project management and customer relations for no extra charge. PP (professional profiles)—Shop/Repair Facility profiles can be upgraded to serve as a public facing website for a monthly fee. Jobs 25—Employers pay a flat fee per job listing. Parts 26—Percentage based fee imposed onto sellers for each part sold; buyers will have the option of upgrading to Prime Parts for a yearly fee. Payments—Add on feature to Estimates for a nominal monthly fee. VIN Reports 42—Flat fee for each report; unlimited report fleet membership program for a monthly or annual fee. Insights 43—Monthly fee for access to data aggregated by all subsegments, all-access membership program for a monthly or annual fee. OEM Hub 44—Still exploring how this should work given each manufacturer has vastly different ways of approaching certifications. Likely a flat fee for each OEM course; paid access to OEM repair guidelines.

The present invention has several uses. The range of features of the present invention go well beyond ensuring the authenticity and transparency of auto parts and service records. The versatile platform, designed with blockchain's unique capabilities in mind, addresses numerous facets of the automotive service industry, creating an ecosystem that benefits all stakeholders—vehicle owners, service providers, insurance companies, and even prospective buyers.

The present invention has enhanced search functionality and special offers. The application's platform, when accessed via the “Automotive Attention Token Blockchain Browser”, empowers customers to search for automotive services, qualifications, and ratings of service providers with unprecedented ease and transparency. Not only does it provide a more efficient way of finding reliable automotive services, but it also incentivizes customer engagement. Users receive tokens, credits, and exclusive offers for using the app, making the process of vehicle upkeep not just simpler, but rewarding.

The application provides automated service reminders and scheduling. One of the core features of the invention is its service reminders and auto-scheduling functionality. Connected to the vehicle via an OBD plug-in, the application is configured to pull all available data, track the vehicle's condition and mileage, and generate service reminders based on the vehicle's specific needs. This feature helps prevent missed maintenance, preserving the vehicle's optimal condition and performance.

The application of the present invention provides for real-time accident notifications and detailed documentation. In the unfortunate event of a collision, the application provides first notice to all parties of interest as delegated by the primary account holder. This includes family members, insurance companies, towing companies, and dealers, ensuring prompt action and coordination. Additionally, all service work performed post-collision is added to the vehicle's data file. The data encompasses the repair shop and technicians' details, parts replaced, warranties, insurance claim information, and more, creating a comprehensive repair and service history.

The present invention provides a comprehensive employment and business hub. The application of present invention also serves as a vibrant hub for registered technicians and auto shops. The application provides a platform where technicians and service centers can browse shop details, showcase their credentials, and leverage the value score rating system to build their reputation. This platform can significantly enhance business opportunities for shops and career prospects for technicians.

The system provides for a transparent parts usage and dealer assurance program. Every part used in a vehicle's repair or service is documented in blockchain network of the current invention, providing complete transparency in parts usage and warranty. The customers can see exactly what parts were used, where they were purchased, and the associated warranty, instilling a high level of trust. In addition, the dealer's post-scan, alignment check, and “Brand Reassurance” seal of approval can further assure customers of quality repair work.

The application of the present invention operates to maintain a scorecard and vehicle value documentation. The application provides a maintenance scorecard, logging all maintenance events like oil changes, brake services, car washes, etc. This comprehensive record, along with the repair history, contributes to the vehicle's overall value. The present invention provides for vehicle valuation by integrating transparent and verifiable data.

The application provides for the reinspection and resale facilitation of the vehicle. Reinspection of repair work by certified OEM shops and dealer ensure the highest level of quality assurance. Moreover, the platform provides an avenue for vehicle owners to list and sell their vehicles, with all the necessary documentation readily available to prospective buyers. Repair estimates can also be easily accessed and translated into any language, making the platform universally user-friendly.

The platform operates to provide a strategy for maximum resale value. The system provides true and verified data to help users achieve the highest possible resale value for their investment. The platform acts as a strategic guide, reminding users of required services and providing live vehicle values and recommendations to maintain and improve the vehicle's value. Users can effectively maintain their vehicles, preserve their value, and maximize their returns on investment.

There is the opportunity to incentivize use of platform of the present invention. One of the most appealing aspects of platform is its gamified approach to user engagement. Customers who actively use the application are rewarded with tokens, credits, and exclusive offers. This not only encourages the adoption of the platform but also fosters a sense of community among its users. By providing tangible incentives, the application engages its users in an active and rewarding ecosystem.

The system provides intelligent service reminders and auto service scheduling. The automated service reminders and scheduling feature of application eliminates the hassle of keeping track of vehicle maintenance schedules. The function of the application provides a reliable way to ensure that no necessary service is missed. This feature also allows for automatic scheduling with providers, saving customers time and enhancing their experience.

The application utilizes real-time OBD data access from a database and provides notifications regarding the OBD data. The application, when connected to the vehicle via an OBD plug-in, can pull all available data in real-time. This allows for a seamless and comprehensive overview of the vehicle's condition. In case of an accident, the app sends out first notifications to all interested parties—including family, insurance, tow companies, and dealers. This real-time response is invaluable during emergencies.

The application provides a means for comprehensive repair and service documentation. Every aspect of vehicle repair and service performed is added to the vehicle's data file within the system. This includes all relevant information about the repair shop, technicians, parts replaced, warranties, and even insurance claim info. By making this data readily accessible, the system reinforces transparency and assures customers about the quality of services they receive.

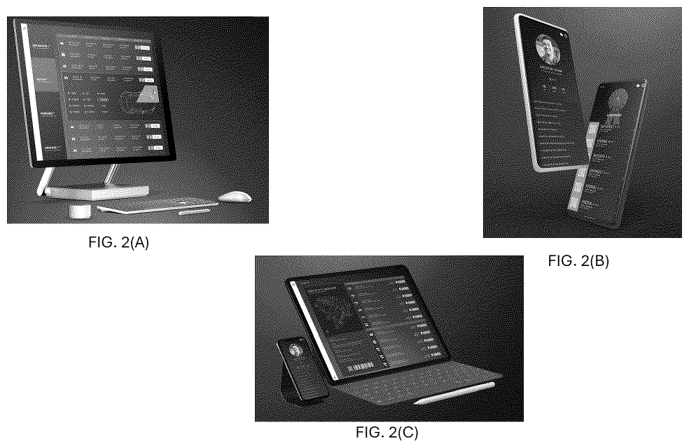

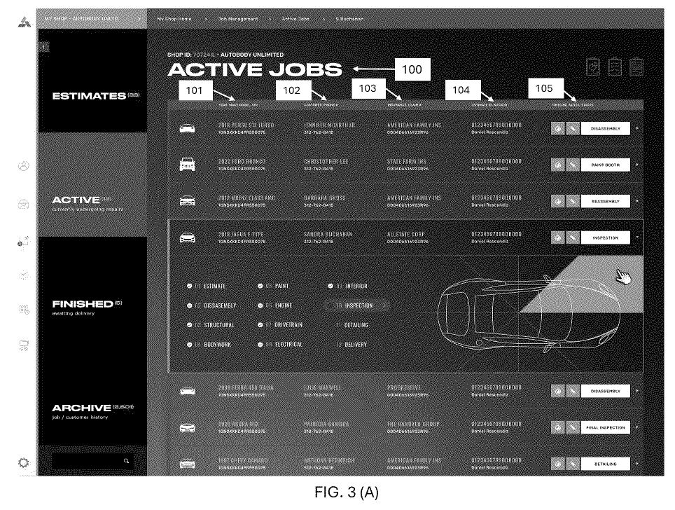

FIGS. 2(A)-2(C) depict the different platforms for utilizing the system 10, include a personal computer FIG. 2(A), a cellular phone FIG. 2(B) and a laptop computer FIG. 2(C).

### Employment and Business Opportunities

The present invention offers a platform that functions as an employment hub utilizing the jobs 25 feature, where registered technicians can explore various shop details and job opportunities. This detailed and updated information can enhance their career prospects and promote excellence within the industry.

Ratings System for Increased Accountability. Customers can rate shops, technicians, and insurance companies. Similarly, shops can provide ratings for parts usage and insurance companies. This two-way feedback mechanism not only improves accountability but also fosters trust among users.

Transparent Parts Documentation. Every part used during repair or service is documented in detail, including the type of part, place of purchase, and warranty information. This ensures customers that no counterfeit parts are used, reinforcing trust in the services received.

Dealer Post Scan and Brand Reassurance. After a service or repair, dealers perform a post-scan and alignment check. The customer receives an “OEM Repair Seal of Approval,” confirming the work's quality. Pre and post-scans are performed and saved, ensuring a thorough record of vehicle condition.

The application provides a diminished value determination to provide a value score for the vehicle. The application records a comprehensive vehicle history which allows for a reliable determination of diminished value following repairs or collisions. This information can be crucial for insurance claims and resale purposes.

The application generates a maintenance scorecard based on the value score and vehicle value documentation. With every maintenance event recorded, including oil changes, brake services, washes, etc., the application provides a holistic view of a vehicle's care by generating a value score for each event associated with the vehicle. This documentation operates to contributes to the generation of a value score relating to the vehicle's value and can impact its resale price positively.

The application provides for certified reinspection and easy resale. The system provides the option for reinspection of repair work by certified OEM shop and dealers. This further assures quality and trust. Vehicle owners can also list and sell their vehicles on the platform, with all necessary documentation readily available to prospective buyers.

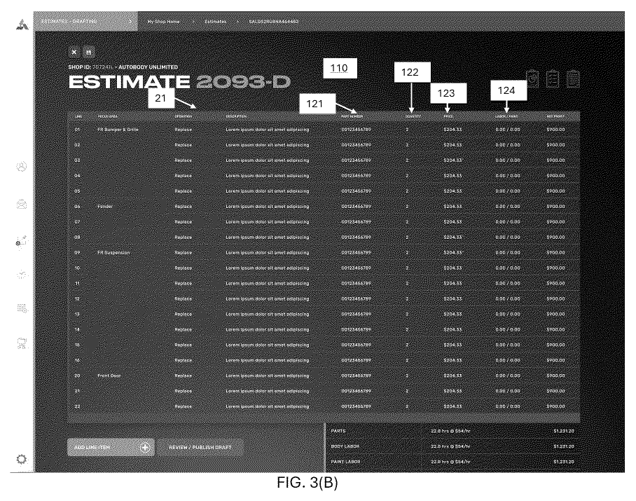

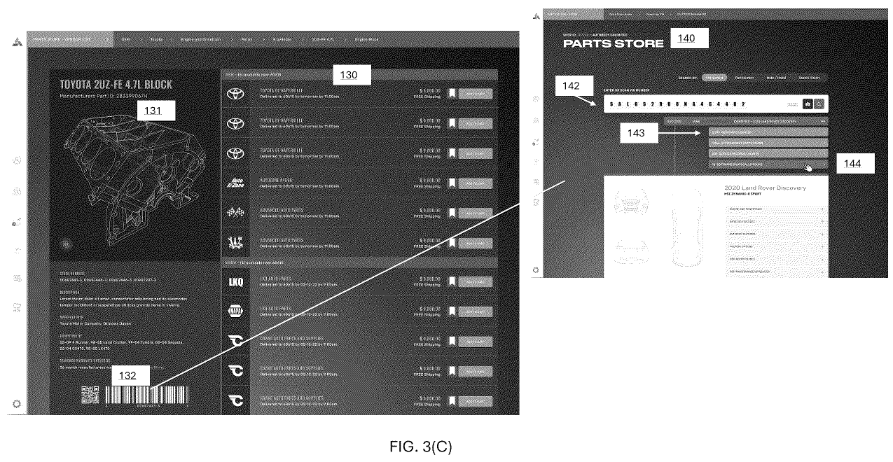

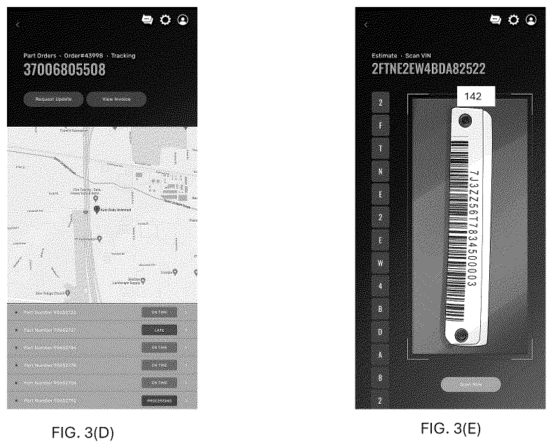

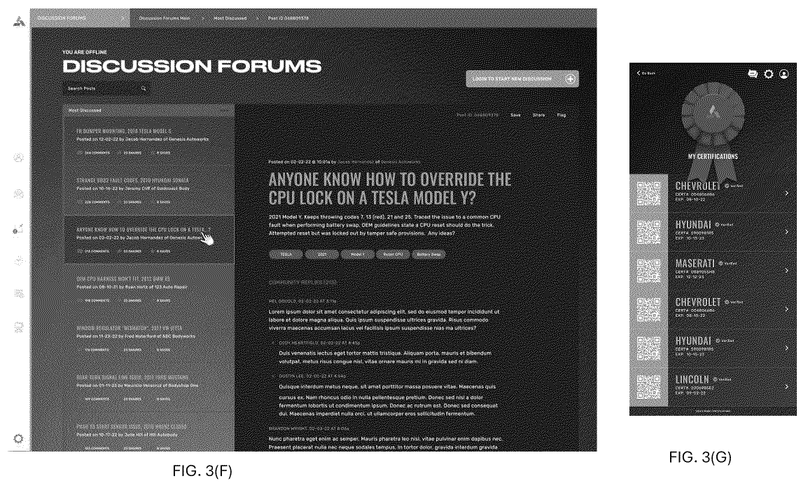

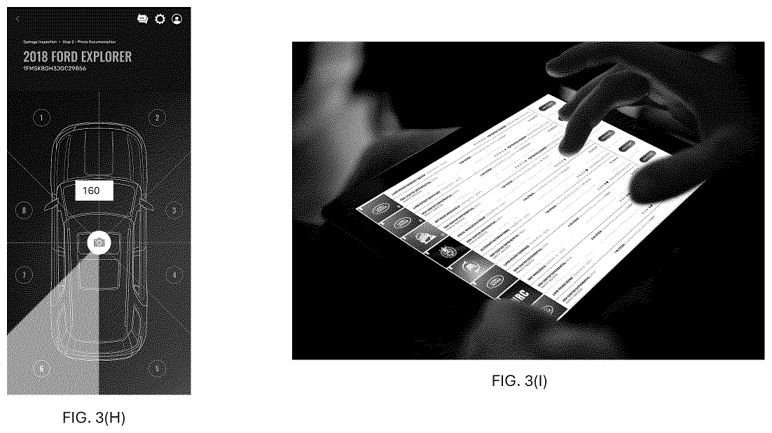

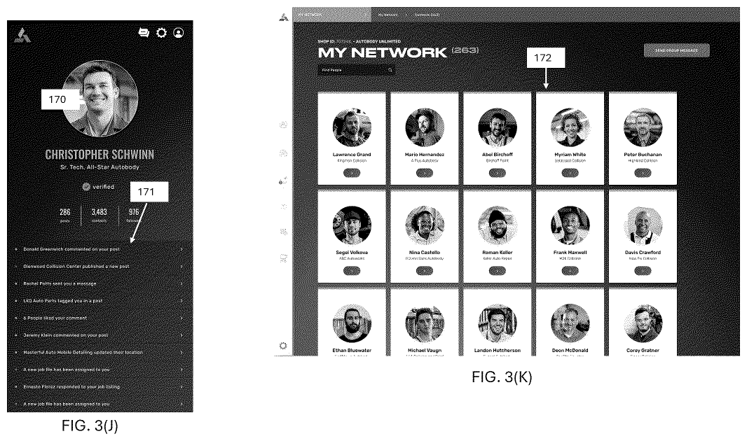

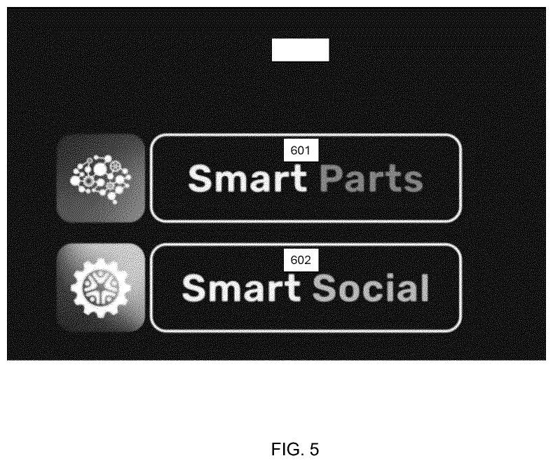

It would be helpful to walk through an example of how the system operates. The application of the present invention 10 is positioned on the internet to allow users to log in and access the application. When a user accesses the application, he or she is offered a comprehensive service that provides service, maintenance and repair records associated with a vehicle. For example, FIG. 3(A) shows a list of active jobs 100 that appear in the application including a list of: (1) the make, model, year and VIN of an automobile 101, (2) the name and information 102 for a customer, (3) the insurance claim no. 103, (4) the estimate 104 for, and author and (5) timeline, notes and status 105. Any of this job information for a particular vehicle may be accessed by the user. Clicking on the automobile 101 icon will provide information related to the specific automobile regarding the estimate, disassembly, structure, bodywork, paint, engine drivetrain, electrical, interior, detailing and delivery will be accessed. When accessed the particular information of each job is displayed for example Estimate, disassembly, structural, bodywork, paint, engine, drivetrain, electrical, interior, inspection, detailing and delivery appear. The jobs could be stored in the archive database, so the user has access to all work and service performed on a specific vehicle. The system shows the estimate form supplied by the system. FIG. 3(B) shows form 110 is stored in a database within the application 10 such that all the estimates 21 for the vehicles use the same form. The estimate 21 includes items such as part number 121, quantity 122, price 123 and labor cost 124. FIG. 3(C) shows the parts list 130 for a particular part 131 as well as the vendors that have the part available. These vendors are all part of the service in the applications. The application tracks all the vendors and when a part is ordered. The bar code 132 on the parts list will pull up a parts store 140. The parts store 140 that includes the VIN 142, OEM certification 144 and service records. The application further provides a map of the location of all the vendors and where the particular selected part is located as shown in FIG. 3(D). The application provides for the user to scan the VIN number 142 of a vehicle, FIG. 3(E) to ensure that the proper vehicle and all the vehicle information is being tracked. The application also provides a discussion platform for the users as shown in FIG. 3(F). The discussion platform may provide advice on repair and maintenance issues. The platform can be used as a discussion forum to present questions and provide answers. The documentation associated with the vehicle includes repair shop, shop certification technician, technicians' credentials, parts usage, warranties, insurance claim info as shown in FIG. 3(G). FIG. 3(H) shows the form provided by the application for recording with pictures 160 of any damage and repair. The application can be accessed from a computer, phone or tablet as shown in FIG. 3(I). The application provides background 170 and certifications 171 associated with the technicians 172 who are members of the platform as shown in FIGS. 3(J) and 5(K).

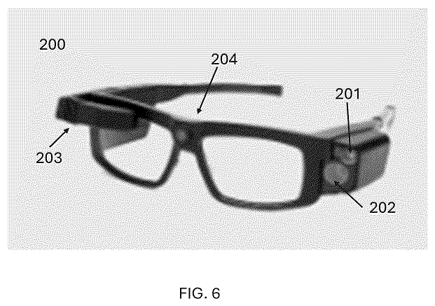

The invention may employ smart safety glasses as shown in FIG. 6 that would work in conjunction with the software. The glasses 200 are configured to operate to: 1) Scan VIN barcode and decode vehicle options, 2) Conduct video repairs, 3) Video conference with other technicians, insurance, or customer, 4) Create vehicle condition reports, 5) Time stamp, 6) Document repairs and prior damage, 7) Uses a LiDAR camera for Thermal imaging, 8) Take photos, 9) Invert photos, 10) Receive repair procedures, 11) Use for diminished value inspections, 12) incorporate a microphone, 13) Translates to other languages 14) Used for repair time studies and repair billing and 15) Scan product barcode to document usage for billing. The glasses 200 include a camera 201 and a video recorder 202. The camera 201 and video recorder 202 scan VIN barcode and decode vehicle options, conduct video repairs, take photographs, document repairs as they are being conducted and thermal imaging to review damage. The glasses 200 also may include a video display 203 that is used to video conference with other technicians, insurance, or customer. The video display 203 may also be used to display repair procedures that should be followed. The glasses include a CPU to perform the above referenced operations. The glasses may further include a microphone 204 to converse with individuals during video conferences, reconceive repair procedures and other voice functions such as documenting repair procedures.

The system provides repair estimates and universal accessibility. The platform provides repair estimates that can be easily accessed and translated into any language, promoting global usability. Its Web 3.0 capabilities ensure seamless, decentralized access to its features.

The platform provides an array of features that solve a wide range of issues prevalent in the automotive repair sector. These features are shown in FIG. 3(A)-(K). Some of the key functionalities include:
A blockchain browser to search for automotive services, qualifications, and ratings.
A reward system that provides tokens, credits, and exclusive offers for using the software/app.
Automated service reminders and scheduling with service providers.
OBD plug-in connectivity to pull all available data and document any service work performed on the vehicle.
Collision first notice of interest for relevant parties.
Detailed employment hub allowing registered technicians to browse shop details.
A robust rating system covering shops, parts usage, insurance companies, and more.
Documentation of parts used, including type, purchase location, and warranty.
Pre and post-repair scans performed and saved for added transparency.
Calculation of diminished value based on comprehensive documentation.
Vehicle maintenance scorecard tracking various services such as oil changes, brakes, washes, etc.
Vehicle listing and selling for vehicle owners.
These functionalities and more are designed to bring an unprecedented level of transparency, efficiency, and trust to the automotive repair industry.

Moreover, the strategic revenue model covers multiple streams such as subscription fees, transaction fees, premium features, and data monetization. Each represents a massive market opportunity, thanks to the colossal size and reach of the global automotive repair and parts industry.

The platform provides a software application and algorithm that operates, and functions as follows:
customer uses automotive attention token blockchain browser to search for automotive services, qualifications and ratings;
customer receives tokens, credits, exclusive offers for using software/app;
service reminders and auto scheduling with providers;
scan-obd plug in connect to software/app and to pull all available data
provide collision first notice to all parties of interest (delegated by primary account holder) family, insurance, tow company, dealer;
any service work performed will be added to the vehicles data file;
full documentation of vehicle repair, service, parts replacement and warranty will be maintained in a database;
the documentation associated with the vehicle includes repair shop, shop certification, technician, technicians credentials, parts usage, warranties, insurance claim info:
the software also provides detailed employment hub (registered technician can browse shop details)
the software documents regarding the ratings of all these items listed by shop (parts usage, insurance companies), client (shop, tech, insurance companies);
all parts usage will be documented by type of part, where the part was purchased and warranty;
parts and services will be purchased through the software;
dealer post scan, alignment check, “brand reassurance” to the customer “oem repair seal of approval” on the platform;
pre & post scans performed & saved
documentation determines diminished value of the vehicle;
vehicle maintenance scorecard including oil changes, brakes, washes etc.;
documentation contributes to vehicles value that is maintained in a database that may be accessed by the software;
full vehicle documentation establishing a standard of vehicle values will be maintained and be accessible by the software and user;
reinspection of repair by certified OEM shop and dealer will be documented;
current owner of original repair will be maintained by the software and a new owner of vehicle will have access to the vehicle score and information after registers with the application;
vehicle owners can list and sell their vehicles using the software;
the score of the vehicle and documentation will be correlated to the vehicle;

The software operates to perform the following functions:
mission/vision/values/results—input true and verified data to achieve the highest resale value of your investment;
strategy map/objectives—reminders of required services to achieve maximum results;
measures and targets—data received by vehicle owner;
initiatives—live vehicle values & recommendations to improve.

The platform provides a certain fee platform for subscription fees. The platform implements a revenue model largely anchored on the subscription fees it charges to automotive repair shops, dealerships, and other service providers. These stakeholders gain access to the comprehensive platform, armed with features designed to boost efficiency, transparency, and overall consumer trust. Considering the trend towards digitalization, the potential for high adoption rates of the platform is considerable. Given the size and scope of the automotive repair market, even a moderate adoption rate can translate into a robust, recurring revenue stream. Furthermore, as the platform continues to develop, adding more features and capabilities, its value proposition and thus, its subscription fee can be dynamically adjusted, offering an additional upward potential to the revenue.

The platform provides recording transaction fees. In addition to subscription fees, the application may further supplement its revenue by collecting transaction fees on the purchase of parts and services made within its platform.

The application provides premium features and services. Another cornerstone of the revenue model for the present invention involves income generated from premium features and services. These offerings extend beyond the basic functionality provided to subscribers, enhancing the user experience and providing advanced capabilities.

The ability to provide data monetization using the platform of the present invention has the unique potential to monetize the vast amount of data it generates. The platform, in its operational capacity, amasses a large variety of data, including vehicle histories, parts data, transaction data, and user behavioral data. By responsibly harnessing and utilizing this data, the application can derive valuable insights and offer data-driven services, all while adhering to privacy and data protection regulations.

Its blockchain-based approach not only promotes transparency and trust but also provides a potential for regulatory advantages, setting the platform up as an essential component of the global automotive repair ecosystem.

The platform of the present invention is an Automotive based “Basic Attention Token,” a blockchain-based system for tracking media consumers' time and attention on websites using the related web browser. Built on Ethereum, its goal is to efficiently distribute advertising money between advertisers, publishers, and readers of online marketing content and ads.

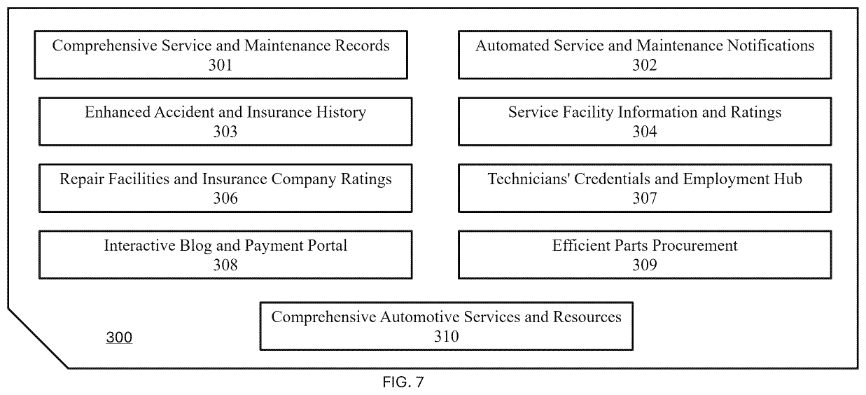

A brief description of the platform 300 for the application of the current invention is set forth as follows and as shown in FIG. 7:

### 1. Comprehensive Service and Maintenance Records 301:

With the current invention, automotive service, maintenance, and repair records can be collected in full detail, including parts usage and warranties. This provides a reliable history of all vehicle maintenance activities, ensuring that crucial information is accessible and verifiable for future reference.

### 2. Automated Service and Maintenance Notifications 302:

The system sends timely notifications to vehicle owners, informing them when service and maintenance are required. This facilitates the seamless scheduling of appointments, ensuring vehicles receive timely care. Vendors can leverage this platform to send promotional messages, providing consumers with relevant offers and discounts.

### 3. Enhanced Accident and Insurance History 303:

The power of blockchain can collect and securely store vehicle owner history, including accidents and filed insurance claims. This database helps potential buyers and insurance providers access accurate and trustworthy information.

### 4. Service Facility Information and Ratings 304:

The platform operates to collect vital service facility information, such as the services offered, and certifications obtained. This data empowers consumers to make informed choices when selecting service providers. The platform allows customers to rate service shops based on factors like parts usage, the number of certified employees, and overall customer experience.

### 5. Repair Facilities and Insurance Company Ratings 306:

In addition to rating service shops, consumers can provide feedback and ratings for insurance companies. This feature ensures that insurers uphold high standards and fosters healthy competition within the market.

### 6. Technicians' Credentials and Employment Hub 307:

The platform operates to collect and verify technician information, including experience and certifications, and a dedicated employment hub connects certified technicians with potential employers.

### 7. Interactive Blog and Payment Portal 308:

The application includes an interactive blog, connecting the public with certified technicians and providing valuable guidance on automotive matters. Additionally, the platform offers a secure payment portal for services, purchases, and insurance claims, ensuring secure and seamless financial interactions.

### 8. Efficient Parts Procurement 309:

The blockchain software of the current invention features a “parts procurement module” that enables users to locate and purchase parts directly from Original Equipment Manufacturer (OEM) warehouses.

### 9. Comprehensive Automotive Services and Resources 310:

The application of the current invention serves as a hub for all automotive services and resources. It provides a centralized platform where consumers can access a wide range of services, including maintenance, repairs, sales, and insurance, while also providing a comprehensive database of automotive resources, guides, and information.

The objective of the software application of the current invention are shown in the system feature of FIG. 7. The software functions to upgrade the arcane state of network technologies in the automotive repair industry. Enabling service providers, vendors and customers access to more effective online tools will streamline B2B and B2C transactions while also elevating operational standards throughout this multi trillion-dollar industry. The problem with the current systems is that despite 4.5 million vehicles entering service each year and 18,000 accidents per day involving two or more vehicles, the automotive repair and servicing industry has shown abnormally slow growth of 2.1% annually. Growth is not the only issue. Compensation has also stagnated despite the scarcity of qualified labor, amongst many other issues native to this industry. After several rounds of extensive research and data collection, it has been determined that a bottleneck can be caused by two factors: 1) the tech poor nature of supporting software available to business owners, vendors and customers. 2) the control mechanisms imposed by dominant insurance providers.

The software of the current invention is aimed at 3 groups: Facilities and Shops, Vendors and Suppliers and Customers. The insurance companies and the resale market offer a secondary level of users of the software.

The software features work synergistically with each other, allowing users to freely move between features on one unified platform. Referring to FIG. 1, the software will operate to conduct the features such as:

Estimates 21—Online estimating tool enabling fast, accurate and transparent job bids. Industry first features such as side by side supplement modification analysis, remote damage assessments and end to end digital (no phone call) estimate scheduling/assessment/delivery.

Project Management 22—Project management software designed to coordinate repair procedures, ensure safe outcomes and feed pertinent data into various subsystems.

Customer Relations Management 23—Customer relations management with online customer accessibility for seamless B2C interactions.

Professional Profiles 24—Intra industry central social networking tool built around professional profiles enabling more effective communication, networking, problem solving and well informed employment/hiring decisions. Shop profiles are designed to also serve as a public facing web page for repair facilities who lack an effective digital presence.

Jobs 25—Employment resource specifically tailored to automotive talent.

Parts 26—Multivendor parts marketplace allowing part vendors to compete side by side.

Payments Hub 41—B2B and B2C payment hub designed to streamline payment collection featuring direct integration with select FinTech brands such as Stripe, PayPal, Apple Pay, Google Pay, Venmo and Crypto intermediaries.

VIN Reports 42—Comprehensive report featuring granular vehicle details and histories to provide an accurate assessment of value and safety standards within the resale market. Vastly superior to CARFAX, KBB, Auto Check and similar reports.

Insights 43—Usage data aggregate imported daily from the features offered on the platform of the present invention. Organized categorically for third party consumption.

OEM Hub 44—Online certification courses, continuing education credits and repair guidelines.

Public Relations 45—Public Information resource aimed at providing vehicle owners with trade insights to assist with assisting in collision repair decisions and resale purchasing.

Smart Contracts 46—Job provisions, auto part warranties and vehicle rental agreements made official via smart contracts.

The platform operates to give users the option to accept various crypto currencies for services and vendor payments alongside traditional currency exchanges. The platform issues authentic VIN reports and vehicle ownership history using blockchain. The platform offers easy to access contract forms used in the automotive industry such as repair contracts, vehicle ownership, lease agreements and insurance policies. The platform will create a “coin” as an use reward mechanism. The coin could be used as a payment mechanism within the platform.

Each core feature has a built-in revenue model enabling all subsegments of the platform to stand independently. A freestanding modular architecture will allow: 1) ROI determination by feature set and 2) subsegments of the platform to be sold if an acceptable opportunity arises. The features of the platform's revenue options include the following:
Estimates 21—Monthly fee imposed for repair facilities. Includes a prime or PM base and CRM base for no extra charge.
Professional Profiles—Shop/Repair Facility profiles can be upgraded to serve as a public facing website for a monthly fee.
Jobs 25—Employers pay a flat fee per job listing.
Parts 26—Percentage based fee imposed onto sellers for each part sold; buyers will have the option of upgrading to an exclusive parts provider for a yearly fee.
Payments 41—Add on feature to Estimates for a nominal monthly fee.
VIN Reports 42—Flat fee for each report; unlimited report fleet membership program for a monthly or annual fee.
Insights 43—Monthly fee for access to data aggregated by all subsegments, all-access membership program for a monthly fee.
OEM Hub 44—Payment of a flat fee for each OEM course and access to OEM repair courses.
Smart Contracts 46—There would be a percentage-based fee to facilitate the contract forms.

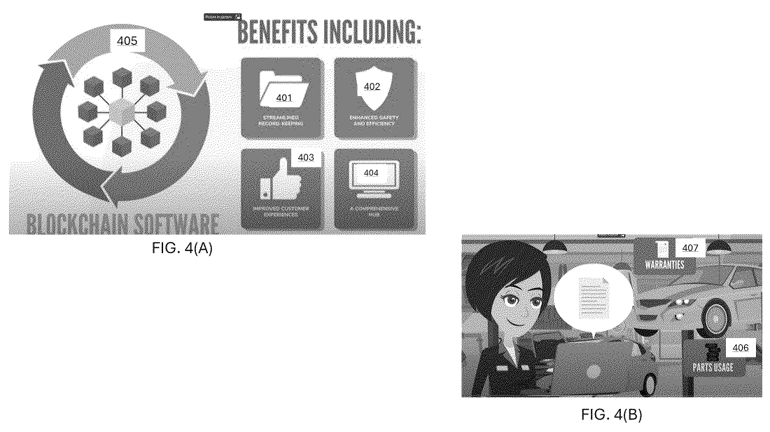

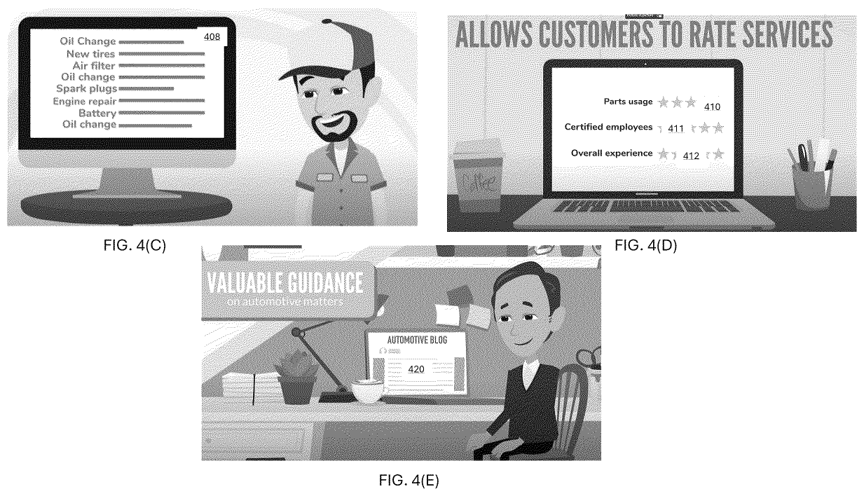

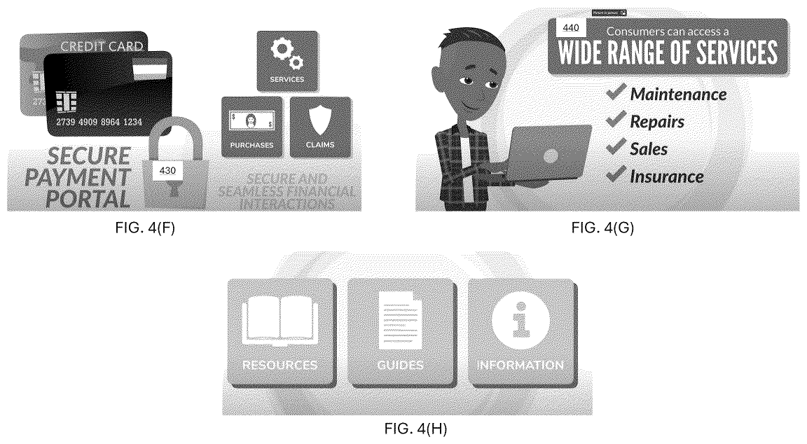

The blockchain 405 software provides the following benefits such as stream-lined record keeping 401, enhanced safety and efficiency 402, improved customer experience 403 and a comprehensive hub 404 as shown in FIG. 4(A). The system uses a basic attention token and manages track time and attention to a project using blockchain software 405. The goal is to accurately distribute money generated from the platform to advertisers, publishers, and readers. The features and advantages of the platform include comprehensive services and maintenance records 401. Automotive service, maintenance and repair records are collected in full detail including parts usage 406 and warranty information 407 as shown in FIG. 4(B). The information provides reliable maintenance and repair information 408 about maintenance such as oil changes, new tires, air filters, oil filters, spark plugs, engine repair, battery, oil change and brake wear as shown FIG. 4(C). The information is acceptable and verifiable for future reference. The platform provides automated service and maintenance notifications. The application provides the seamless scheduling of appointments ensuring vehicles receive timely care. The platform can provide consumers with timely discounts and special offers.

The platform provides enhanced accident and insurance history in a secure database. The database allows owners and potential buyers of vehicles to have access to important information. The users have access to service facility information and ratings. The platform collects vital information regarding services offered and certifications provided. The consumer can use the information to make an informed decision regarding the service and repair of the vehicle. The platform allows the customer to rate services for parts usage 410, employee certification 411 and overall experience 412. FIG. 4(D).

The platform allows customers to generate repair facility and insurance company ratings and review. The platform collects and verifies repair shop information regarding technician credentials and employment hub information. The hub connects certified technicians with potential employers.

There is an interactive blog 420 and payment portal that is part of the platform. The blog connects public certified technicians with valuable guidance on automotive matters. FIG. 4(E). The payment portal 430 provides a secure payment portal that provides seamless financial interactions for services, purchases and claims as shown in FIG. 4(F). The platform provides for efficient parts procurement where the repair shops can purchase or procure parts from the original manufacturer or OEM warehouse.

The platform has a system for comprehensive automotive services and resources. It provides a centralized platform that a consumer can access a wide range of services 440 regarding the maintenance, repair, sale and insurance of the vehicle as shown in FIG. 4(G). The platform also provides a comprehensive database of resources, guides and information as shown in FIG. 4(H).

FIG. 5 is a description of a web enabled parts and services marketplace supported by an integrated social networking platform—a project aimed squarely at disrupting the entire industry. The present invention as shown in FIG. 5 shows two important digital platforms, both of which are prerequisites for sustainable growth: a multivendor parts/service marketplace 601 and a centralized social networking/communication hub 602. The marketplace will focus on:
Accessibility—Ease of access to any part for any vehicle on a global scale.
Simplicity—Every aspect of the parts ordering will be notably easier than it is now.
Reliability—Only buy from proven, peer reviewed vendors who must adhere to a high bar of standards within the platform;
Efficiency—Reduce the average time spent ordering parts by 50% or more.

The social networking platform on the present invention builds a community and organize its members into industry subsegments, continually seed the marketplace with new buyers while keeping existing customers engaged and increase the monetary value of our native altcoin. The platform operates to provide sellers with the ability to pay to unlock an enhanced analytics toolbox in order to refine their sales strategies based on granular user data. It also provides Reverse Logistics. Revers Logistics is a third-party integration that ensures all returns are seamless for both sides. Sellers pay for product listings to be featured at the top of search results for a set period of time. In addition, Ads can be displayed without being too intrusive or disrupting usability.

In general, the system provides consumers and repair shops with information, services and resources necessary to make informed decisions and provide a value on the vehicle for future references. The use of the system will help maintain a vehicle at its highest value. User engagement will be rewarded with fractional amounts of our own cryptocurrency or altcoin. Users will receive this monetary compensation by writing vendor reviews, posting various forms of educational media, participating in surveys, amongst other forms of engagement on our platform. English is not the first language for over 75% of technicians. Therefore, the platform provides users with a multi-language option which will dramatically influence the overall success of this project by increasing engagement within the most underserved subsegments of the collision industry. Sellers will have access to a trove of analytics and user data, enabling them to analyze and refine their marketplace strategies. The platform utilizes AI applications within transactional platforms such as a product marketplace. The present invention employs a simple AI algorithm to automate visible aspects like shipping ETA's, part availability and some forms of customer service. AI can also be useful for hidden aspects such as identifying spam/bots, account security and dataflow optimization. The drawings show the “my contacts” page of the platform that identifies technicians once a user has logged into the platform. The drawings also show the view of the system when a particular VIN number from an automobile is entered into the platform. The make, model and year of the vehicle is displayed as well as other call-ups for vehicle details, specification and select parts that may need to be ordered. The display of the “select parts” call up is also shown.

All functional decisions in the platform are based upon real world data gathered from industry professionals. The platform provides an easy-to-use digital platform that can be used by technicians in the automotive repair industry.

The embodiments of the invention described above in the context of the preferred embodiments and the description of the features of the current invention are not to be taken as limiting the embodiments or features of the inventions to all of the provided details thereof, since modifications and variations of the embodiments or features of the inventions may be made without departing from the spirit and scope of then invention.

What is claimed is:

1. A system and application for use in the automotive industry for monitoring and recording automotive services comprising:
an application accessible by a vehicle owner, a service shop and a parts vendor;
a database containing information related to the vehicle owner, the service shop and the parts vendor;
a database of vehicle information relating to the identity, vehicle owner information and VIN number associated with a plurality of vehicles;
a database of parts information relating to vehicle parts located at the parts vendor;
a platform to input service and maintenance records relating one of the vehicles in the database wherein the information relates to the service provided by the service shop, the parts supplied by the vendor, the information is stored in a database corresponding to the vehicle VIN in which the repairs are preformed;
an automated service and maintenance notifications mechanism to timely send notifications to vehicle owners, informing the owner of service and maintenance issues on a predetermined schedule;
a blockchain that collects and securely stores the vehicle history, including accidents and filed insurance claims;
a parts procurement module that enables users to locate and purchase parts directly from vendors supplying Original Equipment Manufacturer (OEM) parts;
a system to record and provide users with service shop information and rating information regarding the technicians and the vendor associated with a service shop, wherein the application operates to collect service shop information relating to the services offered, and certifications obtained and stores the information in a database; and

2. The system and application for use in the automotive industry for monitoring and recording automotive services of claim 1, further comprising a database of technician information in a service shop relating to the certificates and credentials of a plurality of technicians.

3. The system and application for use in the automotive industry for monitoring and recording automotive services of claim 2, further comprising an interactive blog, connecting the technicians with other certified technicians to provide guidance on automotive matters.

4. The system and application for use in the automotive industry for monitoring and recording automotive services of claim 1, wherein the automated service and maintenance notifications mechanism includes an enhanced accident and insurance history of all services and maintenance preformed on the car which is associated with the VIN number of one of vehicles in the database and records information as the vehicle history.

5. The system and application for use in the automotive industry for monitoring and recording automotive services of claim 3, wherein the automated service and maintenance notifications mechanism includes an enhanced accident and insurance history of all services and maintenance preformed on the car which is associated with the VIN number of one of vehicles in the database and records information as the vehicle history.

6. The system and application for use in the automotive industry for monitoring and recording automotive services of claim 1, further comprising a search mechanism providing owners to review the service shop information and rating information.

7. The system and application for use in the automotive industry for monitoring and recording automotive services of claim 6, further comprising a rating mechanism providing the owner a platform to rate the service shops based on parts usage, the number of certified employees, and overall customer experience,

8. A system and application for use in the automotive industry for monitoring and recording automotive services comprising:
a system database accessible to a vehicle repair facility, a parts provider and a vehicle owner;
the system database configured to cooperate with a digital platform providing the vehicle repair facility, the parts provider and the vehicle owner accesses to features including:
an estimate function to provide online estimating for side by side supplement modification analysis and remote damage assessments;
a project management function configured to coordinate repair procedures and provide pertinent data to the estimate function;
a customer relations management function to provide online access to a customer relations database storing information on various the vehicle repair facility and the parts provider;
a professional profile network enabling communication, networking and problem solving between the vehicle repair facility, the parts provider and the vehicle owner; and
a multivendor parts marketplace providing access to part vendors through the network.

9. The system and application for use in the automotive industry for monitoring and recording automotive services of claim 8, further comprising a payments hub configured to collect payment featuring direct integration an intermediary platform.

10. The system and application for use in the automotive industry for monitoring and recording automotive services of claim 9, further comprising a VIN reports database including vehicle repair and maintenance details and histories associated with a particular vehicle VIN number.

11. The system and application for use in the automotive industry for monitoring and recording automotive services of claim 10, further comprising an OEM Hub database configured to include certification courses, continuing education credits and repair guidelines.

12. The system and application for use in the automotive industry for monitoring and recording automotive services of claim 11, further including a public relations database configured to provide the vehicle owner information to assist in collision repair decisions and resale purchasing.

13. The system and application for use in the automotive industry for monitoring and recording automotive services of claim 12, further comprising a smart contract database providing access to job provisions, auto part warranties and vehicle rental agreements.

14. The system and application for use in the automotive industry for monitoring and recording automotive services of claim 8, wherein the digital platform comprises a token block chain.

15. The system and application for use in the automotive industry for monitoring and recording automotive services of claim 8, wherein the digital platform comprises a website.

16. An eyewear device configured to operate in conjunction with a system for monitoring and recording automotive services automotive comprising:
a safety glass system having a pair of lenses and frame wherein the lenses are constructed of safety glass;
a pair of temples rotatably fixed to the frame;
a camera affixed to the frame or temples configured to record photographs;
a video camera affixed to the frame of temples configured to record video; and
a CPU affixed to the frame or temples, wherein the CPU in connected to the camera and video camera,
the CPU includes a transmitter configured to transmit signals of the recorded photographs and video to the system for monitoring and recording automotive services automotive; and
the CPU is configured to scan and process VIN barcode on a vehicle, document repairs and prior damage and scan product barcode to document part numbers of equipment installed during a repair.

17. The device configured to operate in conjunction with a system for monitoring and recording automotive services automotive of claim 16, further comprising a video display affixed to the frame, wherein the video display is connected to the CPU that is used to video conference with other technicians during the repair process.

18. The device configured to operate in conjunction with a system for monitoring and recording automotive services automotive of claim 17, a microphone and speaker affixed to the frame, wherein the microphone and speaker are connected to the CPU and is configured to allow the microphone to be used to converse with individuals during video conferences, reconceive repair procedures and other voice functions such as documenting repair procedures; and

19. The device configured to operate in conjunction with a system for monitoring and recording automotive services automotive of claim 18, further comprising a LiDAR camera for thermal imaging affixed to the frame and connected to the CPU.

20. The device configured to operate in conjunction with a system for monitoring and recording automotive services automotive of claim 16, the device configured to operate in conjunction with a system for monitoring and recording automotive services automotive to receive repair procedures, conduct a diminished value inspections, conduct video repairs, conference with other technicians, and create vehicle condition report.
